(19) United States
(12) Patent Application Publication
(10) Pub. No.: US 2015/0035940 A1
(43) Pub. Date: Feb. 5, 2015

(54) Systems and Methods for Integrating Audio and Video Communication Systems with Gaming Systems

(71) Applicant: Vidyo Inc., Hackensack, NJ (US)

(72) Inventors: Ofer Shapiro, Fair Lawn, NJ (US); Ran Sharon, Tenafly, NJ (US); Alexandros Eleftheriadis, Tenafly, NJ (US)

(21) Appl. No.: 14/448,890

(22) Filed: Jul. 31, 2014

Related U.S. Application Data
(60) Provisional application No. 61/860,811, filed on Jul. 31, 2013.

(51) Int. Cl. H04N 7/14; H04L 29/08

(52) U.S. Cl. CPC H04N 7/14; H04L 67/16
USPC 348/14.12

(57) ABSTRACT

Systems and methods for the integration of audio and video communication systems with gaming systems are disclosed herein. In one embodiment of the present disclosure, the audio and video communication server uses information from the game engine in order to decide which users are in virtual proximity to a particular user so that it only forwards their audio to the particular user. In another embodiment, additional audio composition streams are associated with the user's audio streams so that they are rendered at receiving endpoints with the spatial positioning intended by the game engine.

### CROSS-REFERENCE TO RELATED APPLICATIONS

This application claims priority to U.S. Provisional Application Ser. No. 61/860,811, filed Jul. 31, 2013, which is incorporated by reference herein in its entirety.

### FIELD

The disclosed subject matter relates to audio and video communication systems as well as systems that allow users to play electronic games.

### BACKGROUND

Subject matter related to the present disclosure can be found in the following commonly assigned patents and/or patent applications: U.S. Pat. No. 7,593,032, entitled “System and Method for a Conference Server Architecture for Low Delay and Distributed Conferencing Applications”; International Patent Application No. PCT/US06/62569, entitled “System and Method for Videoconferencing using Scalable Video Coding and Compositing Scalable Video Servers”; International Patent Application No. PCT/US06/061815, entitled “Systems and methods for error resilience and random access in video communication systems”; International Patent Application No. PCT/US07/63335, entitled “System and method for providing error resilience, random access, and rate control in scalable video communications”; International Patent Application No. PCT/US08/50640, entitled “Improved systems and methods for error resilience in video communication systems”; International Patent Application No. PCT/US11/038003, entitled “Systems and Methods for Scalable Video Communication using Multiple Cameras and Multiple Monitors,” International Patent Application No. PCT/US12/041695, entitled “Systems and Methods for Improved Interactive Content Sharing in Video Communication Systems”; International Patent Application No. PCT/US09/36701, entitled “System and method for improved view layout management in scalable video and audio communication systems”; International Patent Application No. PCT/US12/041695, entitled “Systems and Methods for Improved Interactive Content Sharing in Video Communication Systems”; and International Patent Application No. PCT/US10/058801, entitled “System and method for combining instant messaging and video communication systems.” All of the aforementioned related patents and patent applications are hereby incorporated by reference herein in their entireties.

Video and audio conferencing technology have evolved. Certain traditional architectures relied on servers implementing the switching or transcoding Multipoint Control Unit (MCU) architectures. The switching MCU is a server that connects to all participating endpoints and receives audio and optionally video from them. It then performs audio mixing, and selects which video source to transmit to the participants. A transcoding MCU decoding the incoming video streams, composites them into a new picture, and then performs encoding of the composited video in order to send it to the receiving participants. If personalized layout capability is desired, the composition and encoding is performed separately for each of the receiving participants. The complexity of an MCU may be significant, as it has to perform multiple decoding and encoding operations. The MCU can be expensive, requiring considerable rack space for hardware, and have poor scalability (i.e., it supports a relatively small number of simultaneous connections, with 32 being typical).

Systems implementing the ITU-T Rec. H.323 standard, “Packet-based multimedia communications systems,” incorporated herein by reference in its entirety, can fall in this category. Such systems feature a single audio (and video) connection between an endpoint and a server.

Certain video communication applications allow the sharing of “content”. The term “content” as discussed herein can refer to or include any visual content that is not the video stream of one of the participants. Examples of content include the visual contents of a computer's screen—either the entire screen (“desktop”) or a portion thereof—or of a window where one of the computer's applications may be displaying its output.

Some systems use a “document camera” to capture such content. This camera can be positioned so that it can image a document placed on a table or special flatbed holder, and can capture an image of the document for distribution to all session participants. In other systems, where computers are the primary business communication tool, the document camera can be replaced with a VGA input, so that any VGA video-producing device can be connected. In certain systems, the computer can directly interface with the video communication system using an appropriate network or other connection so that it directly transmits the relevant content material to the session, without the need for conversion to VGA or other intermediate analog format.

ITU-T Rec. H.239, “Role management and additional media channels for H.3xx-series terminals”, incorporated herein by reference in its entirety, defines mechanisms through which two video channels can be supported in a single H.323 session or call. The first channel can be used to carry the video of the participants, and the second can be used to carry a PC graphics presentation or video. For presentations in multipoint conferencing, H.239 can define token procedures to guarantee that only one endpoint in the conference sends the additional video channel, which can then be distributed to all conference participants.

When an H.323 call is connected, signaling defined in ITU-T Rec. H.245, “Control protocol for multimedia communication”, incorporated herein by reference in its entirety, can be used to establish the set of capabilities for all connected endpoints and MCUs. When the set of capabilities includes an indication that H.239 presentations are supported, a connected endpoint can choose to open an additional video channel. The endpoint can request a token from the MCU, and the MCU can check if there is another endpoint currently sending an additional video channel. The MCU can use token messages to make this endpoint stop sending the additional video channel. Then the MCU can acknowledge the token request from the first endpoint which then can begin to send the additional video channel which can contain, as an example, encoded video from a computer's video output at XGA resolution. Similar procedures can be defined for the case when two endpoints are directly connected to each other without an intermediate MCU.

Certain video communication systems used for traditional videoconferencing can involve a single camera and a single display for each of the endpoints. Some systems, for use in dedicated conferencing rooms, can feature multiple monitors. A second monitor can be dedicated to content sharing. When no such content is used, one monitor can feature the loudest speaker whereas another monitor can show some or all of the remaining participants. When only one monitor is available, video and content are switched, or the screen is split between the two.

Video communication systems that run on personal computers (or tablets or other general-purpose computing devices) can have more flexibility in terms of how they display both video and content, and can also become sources of content sharing. Indeed, any portion of the computer's screen can be indicated as source for content and be encoded for transmission without any knowledge of the underlying software application (“screen dumping”, as allowed by the display device driver and operating system software). Inherent system architecture limitations, such as allowing only two streams (one video and one content) with H.300-series specifications, can prohibit otherwise viable operating scenarios (i.e., multiple video streams and multiple content streams).

So-called “telepresence” systems can convey a sense of “being in the same room” as the remote participant(s). In order to accomplish this goal, these systems can utilize multiple cameras as well as multiple displays. The displays and cameras can be positioned at carefully calculated locations in order to give a sense of eye-contact. Some systems involve three displays—left, center, and right—although configurations with two or more than three displays are also available.

The displays can be situated in selected positions in the conferencing room. Looking at each of the displays from any physical position at the conferencing room table can give the illusion that a remote participant is physically located in the room. This can be accomplished by matching the exact size of the person as displayed to the expected physical size of the subject if he or she were actually present at the perceived position in the room. Some systems go as far as matching the furniture, room colors, and lighting, to further enhance the lifelike experience.

Telepresence systems can operate at high definition (HD) 1080p/30 resolutions, i.e., 1080 horizontal lines progressive at 30 frames per second. To eliminate latency and packet loss, the systems can use dedicated multi-megabit networks and can operate in point-to-point or switched configurations (i.e., they avoid transcoding).

Some video conferencing systems assume that each endpoint is equipped with a single camera, although they can be equipped with several displays. For example, in a two-monitor system, the active speaker can be displayed in the primary monitor, with the other participants shown in the second monitor in a matrix of smaller windows. A “continuous presence” matrix layout can permit participants to be continuously present on the screen rather than being switched in and out depending on who is the active speaker. In a continuous presence layout for a large number of participants, when the size of the matrix is exhausted (e.g., 9 windows for a 3×3 matrix), participants can be entered and removed from the continuous presence matrix based on a least-recently active audio policy.

A similar configuration to the continuous presence layout is the “preferred speaker” layout, where one speaker (or a small set of speakers) can be designated as the preferred speaker and can be shown in a window that is larger than the windows of other participants (e.g., double the size).

The primary monitor can show the participants as in a single-monitor system, while the second monitor displays content (e.g., a slide presentation from a computer). In this case, the primary monitor can feature a preferred speaker layout as well, i.e., the preferred speaker can be shown in a larger size window, together with a number of other participants shown in smaller size windows.

Telepresence systems that feature multiple cameras can be designed so that each camera is assigned to its own codec. For example, a system with three cameras and three screens can use three separate codecs to perform encoding and decoding at each endpoint. These codecs can make connections to three counterpart codecs on the remote site, using proprietary signaling or proprietary signaling extensions to existing protocols.

The three codecs are typically identified as “left,” “right,” and “center.” The positional references discussed herein are made from the perspective of a user of the system; left, in this context, refers to the left-hand side of a user (e.g., a remote video conference participant) who is sitting in front of a camera(s) and is using the telepresence system. Audio, e.g., stereo, can be handled through the center codec. In addition to the three video screens, the telepresence system can include additional screens to display a “content stream” or “data stream,” that is, computer-related content such as presentations.

The primary, typically center, codec is responsible for audio handling. The system may have multiple microphones, which are mixed into a single signal that is encoded by the Primary codec. There may also be a fourth screen to display content. The entire system can be managed by a special device labeled as the “controller.” In order to establish a connection with a remote site, the system can perform three separate H.323 calls, one for each codec. This is because certain ITU-T standards do not allow the establishment of multi-camera calls. The architecture is typical of certain telepresence products that use standards-based signaling for session establishment and control.

Telepresence systems face certain challenges that may not be found in traditional videoconferencing systems. One challenge is that telepresence systems handle multiple video streams. Certain videoconferencing systems only handle a single video stream, and optionally an additional “data” stream for content. Even when multiple participants are present, the MCU is responsible for compositing the multiple participants in a single frame and transmitting the encoded frame to the receiving endpoint. Certain systems address this in different ways. For example, the telepresence system can establish as many connections as there are video cameras (e.g., for a three camera systems, three separate connections are established), and provide mechanisms to properly treat these separate streams as a unit, i.e., as coming from the same location.

The telepresence system can also use extensions to signaling protocols, or use protocols such as the Telepresence Interoperability Protocol (TIP). At the time of writing, TIP is managed by the International Multimedia Telecommunications Consortium (IMTC); the specification can be obtained from IMTC at the address 2400 Camino Ramon, Suite 375, San Ramon, Calif. 94583 or from the web site http://www.imtc.org/tip. TIP allows multiple audio and video streams to be transported over a single RTP (Real-Time Protocol, RFC 3550) connection. TIP enables the multiplexing of up to four video or audio streams in the same RTP session, using proprietary RTCP (Real-Time Control Protocol, defined in RFC 3550 as part of RTP) messages. The four video streams can be used for up to three video streams and one content stream.

In both traditional as well as telepresence system configurations, there are inherent limitations of the MCU architecture, in both its switching and transcoding configurations. The transcoding configuration can introduce delay due to cascaded decoding and encoding, in addition to quality loss, and thus may be problematic for a high-quality experience. Switching, on the other hand, can become awkward, such as when used between systems with a different number of screens.

Scalable video coding (‘SVC’), an extension of the well-known video coding standard 11.264 that is used in certain digital video applications, is a video coding technique that is effective in interactive video communication. Since its commercial introduction in 2008, it has been adopted by certain videoconferencing vendors, as it can be used to solve several problems in packet video communications. The bitstream syntax and decoding process are formally specified in ITU-T Recommendation H.264, and particularly Annex G. ITU-T Rec. H.264, incorporated herein by reference in its entirety, can be obtained from the International telecommunications Union, Place de Nations, 1120 Geneva, Switzerland, or from the web site www.itu.int. The packetization of SVC for transport over RTP is defined in RFC 6190, “RTP payload format for Scalable Video Coding,” incorporated herein by reference in its entirety, which is available from the Internet Engineering Task Force (IETF) at the web site http://www.ietf.org.

Scalable video and audio coding has been used in video and audio communication using the Scalable Video Coding Server (SVCS) architecture. The SVCS is a type of video and audio communication server and is described in commonly assigned U.S. Pat. No. 7,593,032, entitled “System and Method for a Conference Server Architecture for Low Delay and Distributed Conferencing Applications”, as well as commonly assigned International Patent Application No. PCT/US06/62569, entitled “System and Method for Videoconferencing using Scalable Video Coding and Compositing Scalable Video Servers,” both incorporated herein by reference in their entirety. It provides an architecture that allows for high quality video communication with high robustness and low delay. Commonly assigned International Patent Application Nos. PCT/US06/061815, entitled “Systems and methods for error resilience and random access in video communication systems,” PCT/US07/63335, entitled “System and method for providing error resilience, random access, and rate control in scalable video communications,” and PCT/US08/50640, entitled “Improved systems and methods for error resilience in video communication systems,” all incorporated herein by reference in their entireties, further describe mechanisms through which a number of features such as error resilience and rate control are provided through the use of the SVCS architecture.

In one example, the SVCS can receive scalable video from a transmitting endpoint and selectively forward layers of that video to receiving participant(s). In a multipoint configuration, and contrary to an MCU, this exemplary SVCS need not perform any decoding/composition/re-encoding. Instead, all appropriate layers from all video streams can be sent to each receiving endpoint by the SVCS, and each receiving endpoint is itself responsible for performing the composition for final display. Therefore, in the SVCS system architecture, all endpoints can have multiple stream support, because the video from each transmitting endpoint is transmitted as a separate stream to the receiving endpoint(s). Of course, the different streams can be transmitted over the same RTP session (i.e., multiplexed), but the endpoint should be configured to receive multiple video streams, and to decode and compose them for display. This feature of SVC/SVCS-based systems provides for flexibility of handling multiple streams.

The same mechanism can be used for audio streams. They are transmitted to the SVCS, which then selectively forwards the ones that are active (according to certain criteria of current or recent voice activity) to the receiving participants. The actual mixing is performed at the receiving endpoint(s). This can offer flexibility in terms of the types of processing that can be performed on the received audio streams.

In addition to telepresence, there have been efforts aimed at improving the audio experience in audiovisual communication systems. Singer et al., in U.S. Pat. No. 5,889,843 (1999), entitled “Methods and systems for creating a spatial auditory environment in an audio conferencing system,” describe methods to spatially position audio sources using a representation of an auditory environment (e.g., using icons representing audio sources), and then produce audio by creating a mix (by panning) that corresponds to the spatial positions. Weiss et al., in U.S. Pat. No. 7,346,654 (2008), entitled “Virtual meeting rooms with spatial audio,” create models of spaces as well as of sound propagation, wherein a user can specify through an interactive application the desired configuration and produce the corresponding spatial audio experience. Kenoyer et al., in U.S. Pat. No. 7,667,728 (2010), entitled “Video and audio conferencing system with spatial audio,” proposes automating the process of detecting the spatial audio configuration. In this case location is obtained through beamforming with integrated microphones on a camera or speakerphone. The audio is then sent in stereo form to other participants. Jouppi et al., in U.S. Pat. No. 7,720,212 (2010), entitled “Spatial audio conferencing system,” describe a method where a remote interface at a listening location allows the listener to virtually position himself or herself at the remote site. In the above cases the spatial information can be created by a special interactive application.

Zhang et al., in U.S. Pat. No. 8,073,125 (2011), entitled “Spatial audio conferencing,” describe a system where three or more audio streams may be used from a conferencing site that features multiple participants to provide spatial audio information. However, this can require customized audio transmission facilities. Oh et al., in U.S. Pat. No. 8,2214,220 (2012), entitled “Method and apparatus for embedding spatial information and reproducing embedded signal for an audio signal,” describe a method in which spatial audio information is embedded into a mono or stereo audio signal. Oh et al. adds “noise” to the signal, but eliminates the need for a separate channel to transfer the spatial positioning data. Acero et al., in U.S. Pat. No. 8,351,589 (2013), entitled “Spatial audio for audio conferencing,” provides a user interface for virtual audio positioning as well as an embedding method using audio watermarking at frequencies below 300 Hz. Vadlakonda et al., in U.S. Pat. No. 8,411,598 (2013), entitled “Telephone user interface to specify spatial audio direction and gain levels,” eliminate the graphical user interface and, instead, allow a telephone keypad to be used to enter spatial positioning information. Virolainen et al., in U.S. Pat. No. 8,457,328 (2013), entitled “Method, apparatus, and computer program for utilizing spatial information for audio signal enhancement in a distributed network environment,” describes methods for capturing spatial audio and communicating it between devices located in different acoustic spaces.

In the above cases, an effort is either in obtaining the spatial positioning information, or in communicating it to remote parties.

An audio and video communication environment using the SVCS architecture provides inherent support for multi-stream transmission. As a result, additional stream types can be added, such as streams that convey spatial positioning information. The fact that the receiver is the one performing the mixing can be an additional benefit. The architecture has similarities with the MPEG-4 Systems architecture, described for example in Avaro et al., “MPEG-4 Systems: Overview,” Signal Processing: Image Communication, Tutorial Issue on the MPEG-4 Standard, Vol. 15, Nos. 4-5, January 2000, pp. 281-298. MPEG-4 provides for a composition stream that is sent alongside the coded media data and which instructs the receiver on how to compose the constituent streams, both visual and audio.

A problem in obtaining the spatial audio information from a natural environment, however, can be a difficult one. Furthermore, it is not often needed in modern communication settings since most participants are participating from their own distinct location. This means that there may be no single audio space that all participants can be considered to be located.

An application for spatial audio is electronic games. Although games in the past were limited to single sites—even if multiple players were involved—the proliferation of the Internet has resulted in all game consoles now featuring Internet connections via WiFi or wired Ethernet connections. Games have been developed that allow users connected to the Internet to play against each other, or with each other in teams. Sometimes these games may be “massive,” in that they support tens or hundreds of simultaneous users. Spatial audio is a very important feature of game environments since it provides important cues to the player regarding the game action. The ability of multiple players to play together over a network connection creates a natural environment for combining audio and video communication with game playing. Certain audio and video communication architectures, however, cannot directly deal with the spatial audio requirements of games, or the low delay requirements required for gaming. It can therefore be necessary to design systems and methods that allow effective audio and video communication in network-based game environments. These techniques can synergistically combine state-of-the-art audiovisual communication technology with the needs of interactive, network-based games.

### SUMMARY

Systems and methods for the integration of audio and video communication systems with gaming systems are disclosed herein. In one embodiment of the present disclosure, the audio and video communication server uses information from the game engine in order to decide which users are in virtual proximity to a particular user so that it only forwards their audio to the particular user. In another embodiment, additional audio composition streams are associated with the user's audio streams so that they are rendered at receiving endpoints with the spatial positioning intended by the game engine.

### BRIEF DESCRIPTION OF THE DRAWINGS

FIG. 1 illustrates the architecture of an exemplary audio and video communication system integrated with a game server, in accordance with one or more embodiments of the disclosed subject matter;

FIG. 2 illustrates the architecture and operation of an exemplary SVCS system in accordance with one or more embodiments of the disclosed subject matter;

FIG. 3 illustrates an exemplary spatial and temporal prediction coding structure for SVC encoding in accordance with one or more embodiments of the disclosed subject matter;

FIG. 4 illustrates an exemplary SVCS handling of spatiotemporal layers of scalable video in accordance with one or more embodiments of the disclosed subject matter;

FIG. 5 illustrates an exemplary algorithm for performing selection of the users from which to forward media data at a server, in accordance with one or more embodiments of the disclosed subject matter;

FIG. 6 illustrates the operation of the video and audio rendering at a receiver, for video (a) and stereo audio (b), in accordance with one or more embodiments of the disclosed subject matter; and

FIG. 7 illustrates an exemplary computer system for implementing one or more embodiments of the disclosed subject matter.

Throughout the figures the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The present disclosure describes an audio or audiovisual communication system that has been integrated with the game actions of a network-based game. In one or more exemplary embodiments of the disclosed subject matter, the gaming system can be integrated with a video communication system, which uses H.264 SVC and is based on the concept of the SVCS (see U.S. Pat. No. 7,593,032, previously cited).

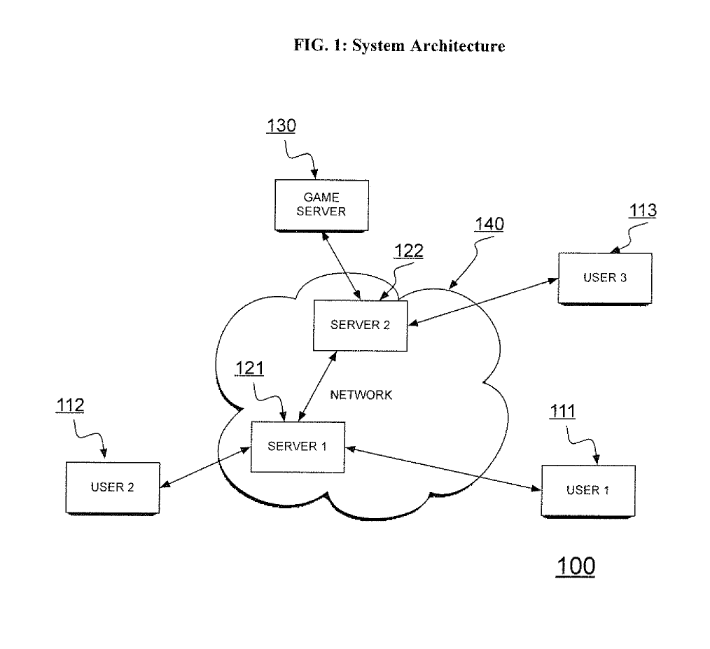

FIG. 1 depicts an exemplary system architecture 100 of a system that combines audio and video communication together with a gaming system. The figure shows three users 111, 112, and 113, by way of example. The system may have anywhere from a single user to thousands of users. The figure also shows two Servers 121 and 122 in a cascade configuration, by way of example. The system may have anywhere from a single Server to any number of Servers. In one embodiment of the disclosed subject matter, the Servers 121 and 122 are SVCS servers. In another embodiment they may be Scalable Audio Conferences Servers (SACS), i.e., SVCS's that feature audio only operation.

The figure also depicts a Game Server 130. The Game Server 130 is shown to be distinct from the Users 111 through 113 as well as the Servers 121 and 122 by way of example, but it can also be co-located, or implemented as part of, any of the User or Server components of the system. In a distributed game environment, every user component of the system (Users 111-113) may implement a copy of the game server functionality, in which case there may be no distinct Game Server 130. Also, more than one Game Server 130 may be present in the system to better manage the load. The Network 140 can be any packet-based network; e.g., an IP-based network, such as the Internet.

The Users 111-113 are assumed to be audio, or audiovisual endpoints, and also feature game-playing capability. One or more embodiments of the disclosed subject matter can use the H.264 standard for encoding the video signals, and the Speex scalable codec for encoding the audio signals. Speex is an open-source audio compression format; a specification is available at the Speex web site at http://www.speex.org. Some of the H.264 video streams can be encoded using single-layer AVC, whereas others can be encoded using its scalable extension SVC. Similarly, some of the Speex audio streams can contain only narrowband data (8 KHz), whereas others can contain narrowband, as well as, or separately, wideband (16 KHz) or ultra-wideband (32 KHz) audio. Alternate scalable codecs can be used, including, for example, MPEG-4/Part 2 or H.263++ for video, or G.729.1 (EV) for audio.

In one or more embodiments of the disclosed subject matter, the Users 111-113 may be using general-purpose computers such as PC or Apple computer, desktop, laptop, tablet, etc. running a software application. They can also be dedicated computers engineered to only run the single software application, for example, using embedded versions of commercial operating systems, or even standalone devices engineered to perform the functions of audiovisual communication and game playing. The software application can be responsible for communicating with the Server(s), for establishing connections and/or for receiving, decoding, displaying or playing back received video, game content and state information, and/or audio streams. The application can also transmit back to a server its own encoded video, game content, and/or audio stream.

Transmitted streams can be the result of real-time encoding of the output of one or more cameras and/or microphones attached to a User 111-113, or they can be pre-coded video and/or audio stored locally on a User 111-113 or Game Server 130, or generated dynamically by the Game Server 130 or the game application running at a User's device.

In one embodiment, all media and game data are transmitted between a Server and a User over a single stream (multiplexed). In other embodiments, each type of content can be transmitted over its own stream or even its own network (e.g., wired and wireless networks).

In accordance with the SVCS architecture, a receiving User 111-113 can compose the received and decoded video streams (as well as any content streams) received from the Server(s) on its display, and can mix and play back the decoded audio streams. It can also receive, and act upon, game data received from other Users or the Game Server 130. Traditional multi-point video servers such as transcoding MCUs may perform this function on the server itself, either once for all receiving participants, or separately for each receiving participant.

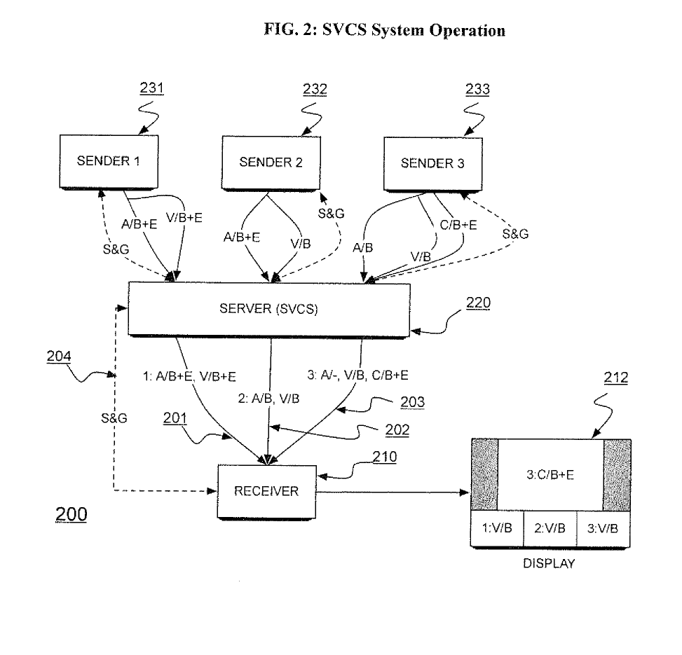

As discussed above, the SVCS system architecture is multi-stream, since each system component must be able to handle multiple streams of each type. Significantly, the actual composition of video and/or mixing of audio typically occurs at the receivers. Returning to FIG. 2, the composition of video and/or content can occur at the Receiver 210. FIG. 2 depicts a single Display 212 attached to the Receiver 210. In this particular example, the system can compose the incoming video and content streams using a “preferred view” layout, in which the content stream from Sender 3 233 can be shown in a larger window (labeled “3:C/B+E” to indicate that it is content from Sender 3 and includes both base and enhancement layers), whereas the video streams from all three senders (1, 2, and 3) can shown in smaller windows (labeled “1:V/B”, “2:V/B”, “3:V/B”, indicating that only the base layer is used).

The layout depicted in FIG. 2 is one example of a SVCS system layout. In another example, in a two-monitor system, the Receiver 210 can display the content stream in one of its two monitors on its own, and the video windows can be shown in the other monitor. Previously cited International Patent Application No. PCT/US09/36701 describes additional systems and methods for layout management. Previously cited International Patent Application No. PCT/US11/038003, “Systems and Methods for Scalable Video Communication using Multiple Cameras and Multiple Monitors,” describes additional layout management techniques specifically addressing multi-monitor, multi-camera systems.

The Servers 121 and 122 coordinate the audio and video communication between the Users 111-113, performing their characteristic selective forwarding function. The Game Server 130 provides the game logic, graphics (if any) and audio special effects, and all other content and interactivity features required by the game. In one embodiment of the disclosed subject matter, the Game Server 130 maintains state information pertaining to the virtual position of Users 111-113 in the game.

The operation of the Servers 121 and 122 is further detailed in FIG. 2. FIG. 2 depicts an exemplary system 200 that includes three transmitting Users, Sender 1 231, Sender 2 232, and Sender 3 233, a Server (SVCS) 220, and a Receiver 210. The particular configuration is just an example; a Receiver can perform the operations of a Sender, and vice versa. Furthermore, there can be more or fewer Senders, Receivers, or Servers as explained earlier. Note that one or more of the Senders may also be a Game Server, transmitting virtual audio and video data. The Receiver 210 may be a Game Server, in which case there may not be a Display 212 as shown, but rather the Game Server may generate content in response to the audio and/or video it receives.

In one or more embodiments of the disclosed subject matter, scalable coding can be used for the video, content, and audio signals. The video and content signals can be coded, e.g., using H.264 SVC with three layers of temporal scalability and two layers of spatial scalability, with a ratio of 2 between the horizontal and/or vertical picture dimensions between the base and enhancement layers (e.g., VGA and QVGA).

Each of the senders, Sender 1 231, Sender 2 232, and Sender 3 233 can be connected to the Server 220, through which the sender can transmit one or more media streams—audio, video and/or content. Each of the senders, Sender 1 231, Sender 2 232, and Sender 3 233 also can have a signaling and gaming data connection with Server 220 (labeled ‘S&G’, for Signaling and Gaming). The S&G connection may be over a reliable transport to ensure accurate delivery, whereas the media transport may be over a best-effort transport to minimize delay.

The streams in each connection are labeled according to: 1) the type of signal, i.e., A for audio, V for video, and C for content; and 2) the layers present in each stream, B for base and E for enhancement. In this particular example depicted in FIG. 2, the streams transmitted from Sender 1 231 to Server 220 includes an audio stream with both base and enhancement layers (“A/B+E”) and a video stream with again both base and enhancement layers (“V/B+E”). For Sender 3 233, the streams include audio and video with base layer only (“A/B” and “V/B”), as well as a stream with content with both base and enhancement layers (“C/B+E”).

The Server 220 can be connected to the Receiver 210; packets of the different layers from the different streams can be received by the Server 220, and can be selectively forwarded to the Receiver 210. Although there may be a single connection between the Server 220 and the Receiver 210, those skilled in the art will recognize that different streams can be transmitted over different connections (including different types of networks). In addition, there need not be a direct connection between such elements (i.e., one or more intervening elements can be present).

FIG. 2 shows three different sets of streams (201, 202, 203) transmitted from Server 220 to Receiver 210. In an exemplary embodiment, each set can correspond to the subset of layers and/or media that the Server 220 forwards to Receiver 210 from a corresponding Sender, and is labeled with the number of each sender. For example, the set 201 can contain layers from Sender 1 231, and is labeled with the number 1. The label also includes the particular layers that are present and/or a dash for content that is not present at all. In the present example, the set of streams 201 is labeled as “1:A/B+E, V/B+E” to indicate that these are streams from Sender 1 231, and that both base and enhancement layers are included for both video and audio. Similarly, the set 203 is labeled “3:A/−, V/B, C/B+E” to indicate that this is content from Sender 3 233, and that there is no audio, only base layer for video, and both base and enhancement layer for content.

With continued reference to FIG. 2, each of the senders, Sender 1 231, Sender 2 232, and Sender 3 233, can transmit one or more media (video, audio, content) to the Server 220 using a combination of base or base plus enhancement layers. The particular choice of layers and/or media can depend on several factors, as discussed later on.

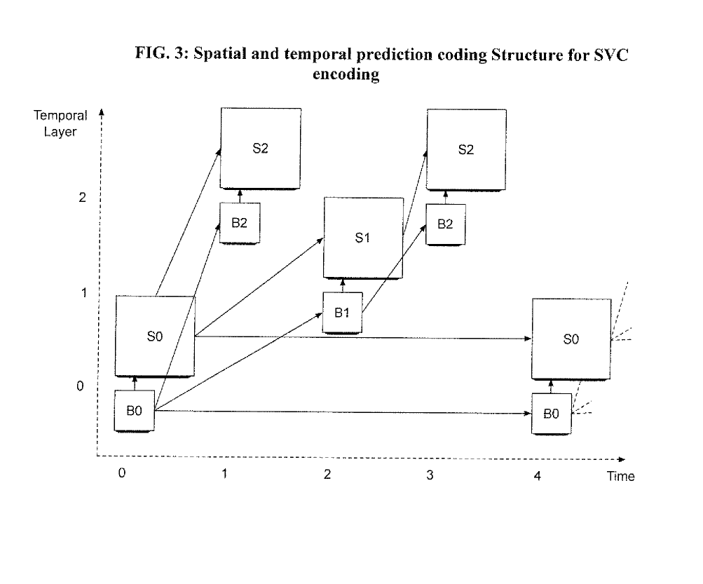

An exemplary spatiotemporal picture prediction structure for use in SVC-based video coding in one or more embodiments of the disclosed subject matter is shown in FIG. 3. The elements labeled with the letter “B” designate a base layer picture whereas the elements labeled with the letter “S” designates a spatial enhancement layer picture. The number following the letter “B” or “S” in each label indicates the temporal layer, 0 through 2. Other scalability structures can also be used, including, for example, extreme cases such as simulcasting (where no interlayer prediction is used). Similarly, the audio signal can be coded with two layers of scalability, narrowband (base) and wideband (enhancement). Although scalable coding is assumed in some embodiments, the disclosed subject matter can be used in any videoconferencing system, including legacy systems that use single-layer coding.

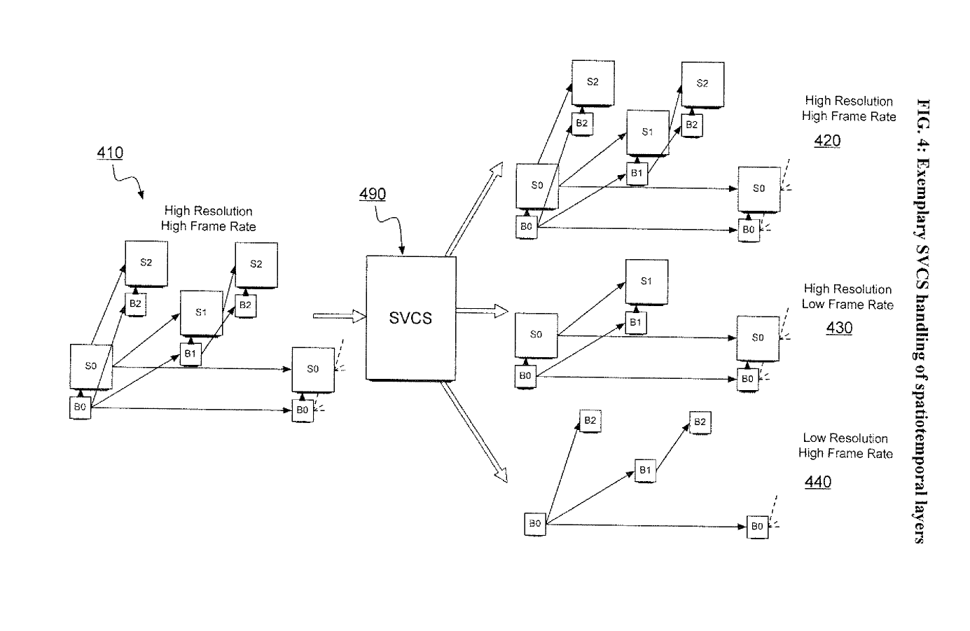

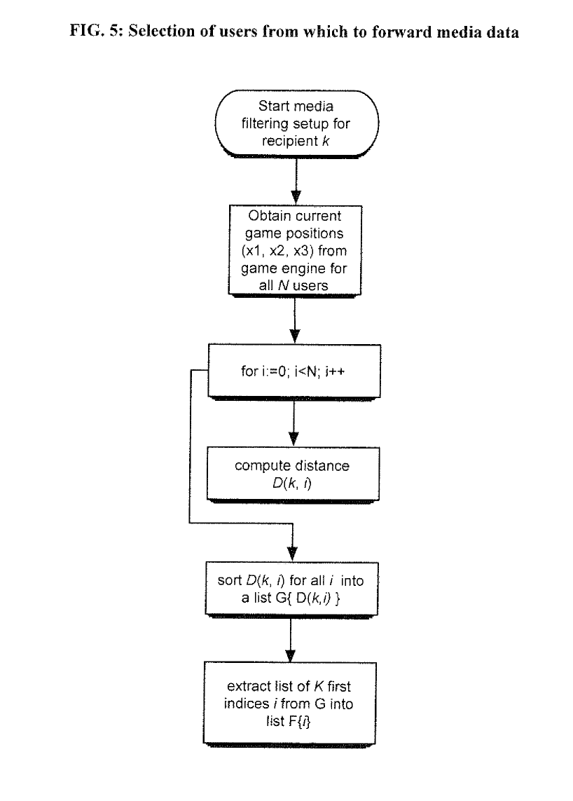

FIG. 4 illustrates an exemplary handling by an SVCS of different layers present in the spatiotemporal picture prediction structure of FIG. 3. FIG. 4 shows a scalable video stream that has the spatiotemporal picture prediction structure 410 of FIG. 4 being transmitted to an SVCS 490. The SVCS 490 can be connected to three different endpoints (not shown in FIG. 4). The three endpoints can have different requirements in terms of the picture resolution and/or frame rates that each endpoint can handle, and can be differentiated in a high resolution/high frame rate 420, high resolution/low frame rate 430, and low resolution/high frame rate 440 configuration. For the high resolution/high frame rate endpoint, the system can transmit all layers; the structure can be identical to the one provided at the input of the SVC 490. For the high resolution/low frame rate configuration 430, the SVCS 490 can remove the temporal layer 2 pictures (B2 and S2). Finally, for the low resolution/high frame rate configuration 440, the SVCS 490 can remove all the “S” layers (i.e., S0, S1, and S2). FIG. 5 is one example, and different configurations and different selection criteria can be used.

In video and audio communication systems using the SVCS architecture, audio activity may be used to perform selection. With reference to FIG. 2, if a Sender 231-233 is not an active speaker, no audio may be transmitted by that Sender. Similarly, if a participant is shown at low resolution, no spatial enhancement layer may be transmitted from that particular participant. Network bitrate availability can also dictate particular layer and/or media combination choices. Layout choices a the Receiver 210, as described in previously cited International Patent Application No. PCT/US09/36701 may also dictate particular combinations.

These and/or other criteria also can be used by the Server 220 in order to decide which packets (corresponding to layers of particular media) to selectively forward to Receiver 220. These criteria can be communicated between Receiver 210 and the Server 220, or between the Server 220 and one of the senders Sender 1 231, Sender 2 232, and Sender 3 233, through appropriate signaling channels (labeled as “S&G,” e.g., 204).

In one embodiment of the disclosed subject matter, the gaming data that is communicated between the Senders 231-233, the Server 220, and the Receiver 210, as well as any Game Servers (not shown in FIG. 2), may provide information that can be used by the Server 220 in order to decide whether or not to forward audio or video data.

Specifically, using the physical model that the game may employ, the Server 220 may select which information to forward based on the virtual proximity of a participant to the Receiver 210. The proximity can be established by taking, as an example, the Euclidean distance between the location coordinates of each of the users in the virtual world maintained by the game. If the (3D) location of participant j is denoted by the vector (x₁^{j},x₂^{j},x₃^{j}), then the Euclidean distance D(i, j) between participants i and j is:

$$D ( i , j ) = \sqrt{{\sum }_{k = 1}^{3} {( {x}_{k}^{i} - {x}_{k}^{j} )}^{2}} \qquad ( 1 )$$

Alternative distance measures such as the sum of absolute differences may be used instead of the Euclidean distance. For the sum of absolute differences the distance D′(i,j) is given by:

$${D}^{′} ( i , j ) = {\sum }_{k = 1}^{3} \vert {x}_{k}^{i} - {x}_{k}^{j} \vert \qquad ( 2 )$$

The Server 220 may elect to forward information on only a set number K of the nearest participants, e.g., three or four. In other words, for a given participant k, it may compute d(k, i) for all i and forward audio and video data only for the participants giving the lowest K values.

As the location of the participants changes, the information is propagated through the Gaming data channels, and thus the Server 220 may change which participants it forwards to the Receiver 210.

In an embodiment of the disclosed subject matter, the Server 220 may forward to the Receiver 210 information pertaining to the spatial location for the audio and/or video signals. This information may be computed at the Receiver 210 based on available Game data, or it may be directly generated by a Game Server (not shown in FIG. 2), connected to the Server 220. In one embodiment of the disclosed subject matter, the information may include a location vector (x₁^{j},x₂^{j},x₃^{j}). The information may be encoded together with information that allows the Receiver 210 to associate the information with the appropriate user and audio and video streams. The encoded information may be transmitted over the audio and video channel, or it may be transmitted over the S&G channel.

For the audio signals, the spatial information may include proximity and directional information, in order to allow the Receiver 210 to properly mix—in terms of level (distance) and direction (panning)—the audio signal with the other participants. If the Receiver's 220 is monophonic, the distance information can still be used to position the audio source. More sophisticated positioning can be performed using stereo and, or course, surround sound configurations (e.g., 5.1, or 7.1).

As is well known to persons skilled in the art, audio intensity falls off (in dB SPL) based on the logarithm of the ratio of the target distance from a reference distance. In other words, if the audio intensity at a distance D_{R} is S_{R} (in dB SPL), then at a distance D the intensity S is:

$$S = {S}_{R} - 20 log \frac{D}{{D}_{R}} ( in dB SPL ) \qquad ( 3 )$$

More complicated models may be used, taking into account virtual atmosphere models, including temperature and relative humidity, which cause frequency-dependent attenuation.

For video signals, the Server 220 may select to forward again only the video information of participants that are in close virtual proximity to the Receiver 210 or some other suitable game target. In another embodiment, it may select to forward video information of participants that are within view of the Receiver 210 or some other suitable game view.

In one embodiment, the Receiver 210 may render received video streams on top of game avatars, in game-specific locations on the Receiver's Display 212. In another embodiment, the Receiver 210 may render the received video streams in a dedicated area of the Display 212. In yet another embodiment, the Receiver 210 may scale the size of each window to indicate the relative distance from the virtual position of the Receiver 210 or some other suitable game target. In another embodiment, the Receiver 210 can arrange the received video in a dedicated part of the screen but in a configuration that reflects the virtual 3D location of each participant. In another embodiment, the Receiver 210 may display video from users who may not be within view of the Receiver 210 (or other suitably selected viewpoint), but would be helpful to the Receiver 210 if they are displayed together. One example is the video of players that are behind the Receiver 210 in the virtual world of the game, but who enter, say, a castle together with the Receiver 210.

FIG. 5 depicts an exemplary algorithm to be used at a Server 220 to establish for a particular Receiver 210 k which of the media streams of the other participants to forward. The algorithm first obtains the current game positions from the game engine for all N users participating in the game, or relevant for the context of the game (e.g., they are at the same level, same game room, etc.) (at 520). It then computes the distance of each user from the user k associated with the Receiver 210 (550). The results are sorted into a list G{ } (560), and finally the indices of the first K entries are retrieved into a list F{ } (570). The list F{ } provides the indices of the users for which media should be sent from the Server 220 to the Receiver 210. In addition, the Server 220 may also send spatial positioning information to the Receiver 210 so that it can perform appropriate spatial positioning during audio mixing or video composition.

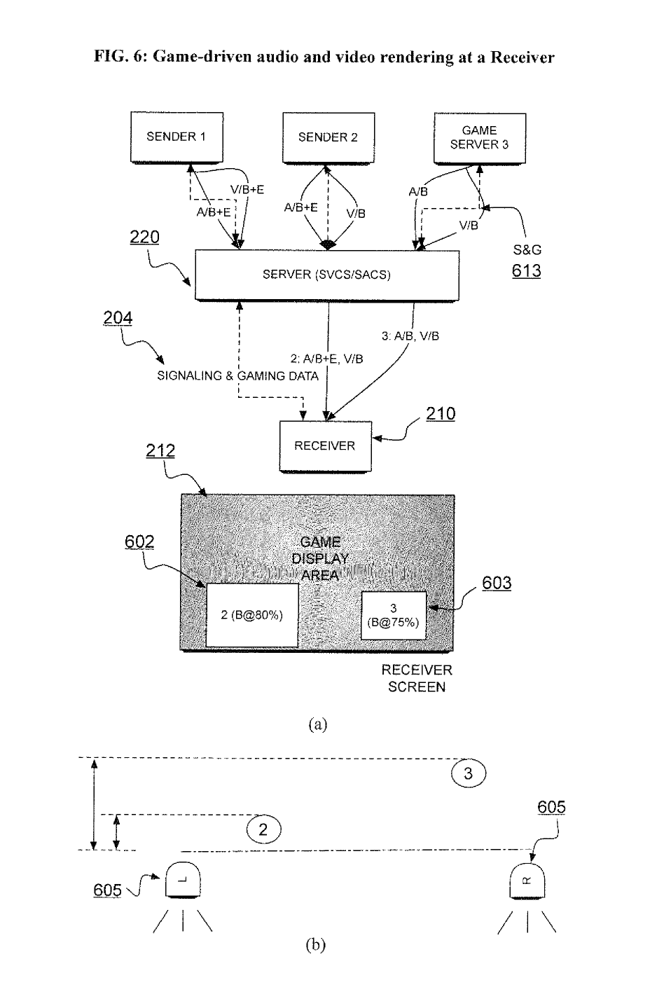

FIG. 6 depicts exemplary rendering operations for a Receiver 220, both for video (FIG. 6(a)) and for audio (FIG. 6(b)). With reference to FIG. 6(a), a Server 220 can be connected, by way of example, to two Senders (Sender 1 and Sender 2) as well as a Game Server 3. The latter is assumed to produce virtual audio and video data, e.g., as it would correspond to a computer-operated/controlled player. All Senders and the Game Server can also feature Signaling and Gaming connections S&G 613. The Server 220 can use the gaming data provided by the Senders 1 and 2 as well as the Game Server 3 in order to decide which media data, and associated spatial positioning data, to forward to the Receiver 210. By way of example, it can be assumed that it decides to forward full audio (base and enhancement) and base video from Sender 2, and base audio and base video for Game Server 3. It also forwards associated spatial positioning information through the Signaling and Gaming Data connection 204.

The Receiver 210 can use the spatial positioning information to position the received video on the Receiver Screen 212. In this particular example, Sender 2 can be assumed to be positioned to the left at a size equal to 80% of the original base layer and that the Game Server 3 is positioned to the right at a size equal to 75% of the original base layer. The exact positioning of the video windows can be computed by the relative positioning of the Sender 2 and Game Server 3 with respect to the position and viewpoint of the user associated with Receiver 210. As mentioned above, other strategies for positioning the video windows can be utilized, including placement at a fixed position on the screen with ordering indicative of the relative positioning.

FIG. 6(b) depicts the operation of mixing of the audio signal using spatial positioning information. The diagram shows the distance of Sender 2 (circle labeled “2”) and Game Server 3 (circle labeled “3”) from the user associated with Receiver 210, as well as the horizontal positioning. The latter can be used to pan the corresponding audio stream to the left (“L”) and right (“R”) Speakers 605. Similar techniques can be used for monophonic or surround sound configurations.

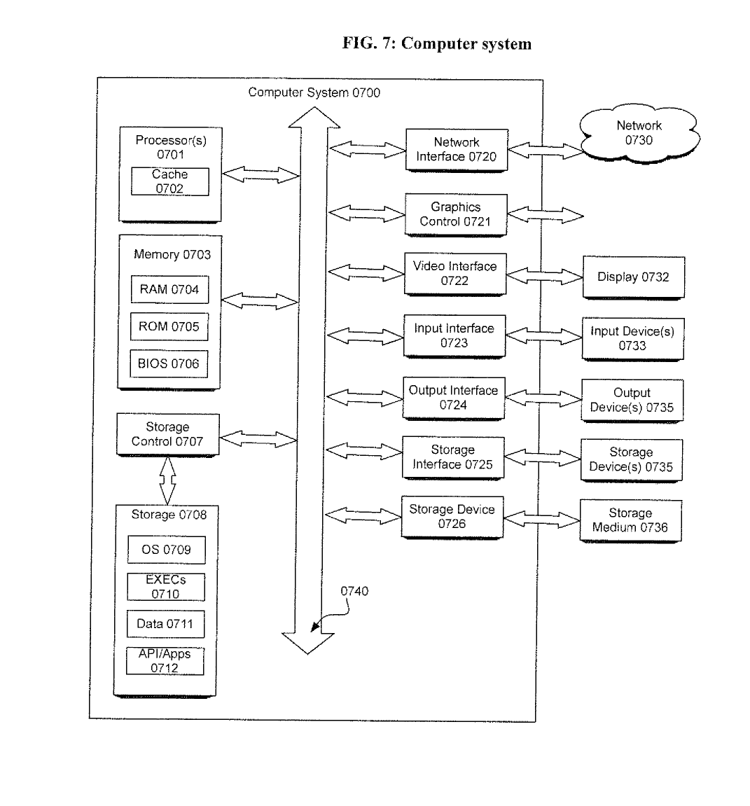

The methods for integrating audio and video communication systems with gaming systems described above can be implemented as computer software using computer-readable instructions and physically stored in computer-readable medium. The computer software can be encoded using any suitable computer languages. The software instructions can be executed on various types of computers. For example, FIG. 7 illustrates a computer system 0700 suitable for implementing embodiments of the present disclosure.

The components shown in FIG. 7 for computer system 0700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 0700 can have many physical forms including an integrated circuit, a printed circuit board, a small handheld device (such as a mobile telephone or PDA), a personal computer or a super computer.

Computer system 0700 includes a display 0732, one or more input devices 0733 (e.g., keypad, keyboard, mouse, stylus, etc.), one or more output devices 0734 (e.g., speaker), one or more storage devices 0735, various types of storage medium 0736.

The system bus 0740 link a wide variety of subsystems. As understood by those skilled in the art, a “bus” refers to a plurality of digital signal lines serving a common function. The system bus 0740 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 0701 (also referred to as central processing units, or CPUs) optionally contain a cache memory unit 0702 for temporary local storage of instructions, data, or computer addresses. Processor(s) 0701 are coupled to storage devices including memory 0703. Memory 0703 includes random access memory (RAM) 0704 and read-only memory (ROM) 0705. As is well known in the art, ROM 0705 acts to transfer data and instructions uni-directionally to the processor(s) 0701, and RAM 0704 is used typically to transfer data and instructions in a bi-directional manner. Both of these types of memories can include any suitable of the computer-readable media described below.

A fixed storage 0708 is also coupled bi-directionally to the processor(s) 0701, optionally via a storage control unit 0707. It provides additional data storage capacity and can also include any of the computer-readable media described below. Storage 0708 can be used to store operating system 0709, EXECs 0710, application programs 0712, data 0711 and the like and is typically a secondary storage medium (such as a hard disk) that is slower than primary storage. It should be appreciated that the information retained within storage 0708, can, in appropriate cases, be incorporated in standard fashion as virtual memory in memory 0703.

Processor(s) 0701 is also coupled to a variety of interfaces such as graphics control 0721, video interface 0722, input interface 0723, output interface 0724, storage interface 0725, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 0701 can be coupled to another computer or telecommunications network 0730 using network interface 0720. With such a network interface 0720, it is contemplated that the CPU 0701 could receive information from the network 0730, or output information to the network in the course of performing the above-described method. Furthermore, method embodiments of the present disclosure can execute solely upon CPU 0701 or can execute over a network 0730 such as the Internet in conjunction with a remote CPU 0701 that shares a portion of the processing.

According to various embodiments, when in a network environment, i.e., when computer system 0700 is connected to network 0730, computer system 0700 can communicate with other devices that are also connected to network 0730. Communications can be sent to and from computer system 0700 via network interface 0720. For example, incoming communications, such as a request or a response from another device, in the form of one or more packets, can be received from network 0730 at network interface 0720 and stored in selected sections in memory 0703 for processing. Outgoing communications, such as a request or a response to another device, again in the form of one or more packets, can also be stored in selected sections in memory 0703 and sent out to network 0730 at network interface 0720. Processor(s) 0701 can access these communication packets stored in memory 0703 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 0700 can provide functionality as a result of processor(s) 0701 executing software embodied in one or more tangible, computer-readable media, such as memory 0703. The software implementing various embodiments of the present disclosure can be stored in memory 0703 and executed by processor(s) 0701. A computer-readable medium can include one or more memory devices, according to particular needs. Memory 0703 can read the software from one or more other computer-readable media, such as mass storage device(s) 0735 or from one or more other sources via communication interface. The software can cause processor(s) 0701 to execute particular processes or particular parts of particular processes described herein, including defining data structures stored in memory 0703 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It will thus be appreciated that those skilled in the art will be able to devise numerous systems and methods which, although not explicitly shown or described herein, embody the principles of the disclosed subject matter and are thus within its spirit and scope.

What is claimed is:

1. A system for communicating one or more signals to at least one receiving endpoint over a communication channel, wherein the one or more signal are encoded in a layered format, the system comprising:
a communication server coupled to the at least one receiving endpoint by the at least one communication channel, and
a gaming server coupled to the communication server over at least one second communication channel,
wherein the communication server is configured to receive the one or more signals,
wherein the communication server is further configured to receive location information associated with each of the one or more signals from the gaming server over the at least one second communication channel, and
wherein the communication server is further configured to select one or more layers of each of the one or more signals to forward to the at least one receiving endpoint using the location information associated with each of the one or more signals.

2. The system of claim 1, wherein the communication server is further configured to receive location information associated with the at least one receiving endpoint, and wherein the communication server is further configured to select and forward a number of signals that are closest to the location associated with the at least one receiving endpoint.

3. The system of claim 2, wherein the communication server is further configured to forward all signal layers for a first number of signals that are closest to the location of the receiving endpoint, fewer layers for a second number of signals that are next closest to the location of the receiving endpoint, and no layers for the remaining signals.

4. The system of claim 1, wherein the at least one receiving endpoint is further configured to receive composition information associated with the one or more signals, and wherein the receiving endpoint is further configured to use the composition information when regenerating the one or more signal.

5. The system of claim 4, wherein the composition information includes at least one of distance, spatial location, and angle.

6. The system of claim 1, wherein the at least one receiving endpoint is further configured to generate composition information associated with the one or more signals, and wherein the at least one receiving endpoint is further configured to use the composition information when regenerating the one or more signal.

7. The system of claim 6, wherein the composition information includes at least one of distance, spatial location, and angle.

8. A method for communicating one ore more signals to at least one receiving endpoint over a communication channel, wherein the one or more signal is encoded in a layered format, the method comprising:
at a communication server, receiving the one or more signals and associated location information,
at the communication server, selecting one or more layers of each of the one or more signals to forward to the at least one receiving endpoint using the location information associated with each of the one or more signals.

9. The method of claim 8, further comprising:
at the communication server, receiving location information associated with the at least one or more endpoint, and
selecting and forwarding a number of signals that are closest to the location associated with the at least one receiving endpoint.

10. The method of claim 9, further comprising: at the communication server, forwarding all signal layers for a first number of signals that are closest to the location of the receiving endpoint, fewer layers for a second number of signals that are next closest to the location of the receiving endpoint, and no layers for the remaining signals.

11. The method of claim 8, at the receiving endpoint,
receiving composition information associated with the one or more signals, and
using the composition information when regenerating the one or more signal.

12. The method of claim 11, wherein the composition information includes at least of distance, spatial location, and angle.

13. The method of claim 8, at the receiving endpoint,
generating composition information associated with the one or more signals, and
using the composition information when regenerating the one or more signal.

14. The method of claim 13, wherein the composition information includes at least one of distance, spatial location, and angle.

15. A non-transitory computer readable medium comprising a set of executable instructions to direct a processor to perform the methods recited in one of claims 8-14.
